(19) United States
(12) Patent Application Publication
(10) Pub. No.: US 2007/0165409 A1
(43) Pub. Date: Jul. 19, 2007

(54) Projection display and image display method

(76) Inventors: Yusaku Shimaoka, Osaka (JP); Hiroshi Miyai, Hyogo (JP); Takaaki Gyoten, Hyogo (JP)

Correspondence Address: RATNERPRESTIA, P.O. BOX 980, VALLEY FORGE, PA, 19482, US

(21) Appl. No.: 10/587,759

(22) PCT Filed: Jan. 26, 2005
(86) PCT No.: PCT/JP05/01021

§ 371 Date: Jul. 28, 2006

(30) Foreign Application Priority Data
Jan. 28, 2004 (JP) 2004-019585

(51) Int. Cl. F21V 7/00

(52) U.S. Cl. 362/299

(57) ABSTRACT

A projection display apparatus of good portability capable of realizing brightness equivalent to that of a conventional display apparatus and displaying a bright projected image upon supply of power has an extra high pressure mercury lamp, a lamp unit for thereby generating first light and light-emitting diodes, and includes a solid state light source unit for thereby generating second light, a movable mirror and a mirror portion adjusting mechanism for selectively guiding the first light or the second light to reflective indicating elements, and a projection lens for projecting the light modulated by the reflective indicating elements.

This application is a U.S. national phase application of PCT International Application PCT/JP2005/001021, filed Jan. 26, 2005.

### TECHNICAL FIELD

The present invention relates to a projection display apparatus for projecting video on a screen by using a light generating instrument, collection optics, a light modulation element and a projection instrument, and the like.

### BACKGROUND ART

In recent years, a projection display apparatus (projector) using various light modulation elements has been receiving attention as a projection video apparatus capable of image magnification. This kind of projection display apparatus illuminates light modulation elements which can perform light modulation with a DMD (digital micro-device) capable of changing a direction of reflection by means of a transmissive or reflective liquid crystal, or minute mirrors arranged like an array by using light radiated from a light source as a light generating instrument, forms an optical image corresponding to a video signal supplied from outside on the light modulation element, and magnifies and projects the optical image which is illuminating light modulated by the light modulation element on a screen by using a projection lens.

Important optical characteristics of this projected large screen are optical output (brightness) emitted from the projection lens and brightness uniformity in its display screen.

Recently, attention has been directed, as important items for the projection display apparatus, to comprehensive functions required as a general image display apparatus such as an instantaneous lighting performance of reducing time for the brightness of an image displayed on the screen to take from power-on to reaching maximum brightness and easiness of installation and portability.

FIGS. 13 and 14 show the projection display apparatus, which uses a light source apparatus 3 using a conventional extra high pressure mercury lamp 1, a lighting unit 35 composed of an optical instrument which allows uniform lighting, reflective indicating elements 41(a) to 41(c) as the light modulation elements described later and a projection lens 51 and others. Here, a light emitting principle of the extra high pressure mercury lamp is as follows. The mercury encapsulated in a vessel evaporates and flows convectively in the vessel as temperature in the vessel is increased by arc discharge between electrodes due to power-on. The light is emitted when the evaporated mercury is excited in an arc portion and returns to e ground state.

As for the optical instrument which allows the uniform lighting, a glass column or a rod integrator 32 like a hollow cylinder composed of bonded mirrors shown in FIG. 14 are used. As for the rod integrator 32, the light having entered from an incident side opening propagates inside a rod by repeating total reflection and reflection on a mirror surface in the rod integrator 32 so as to emit uniform luminous flax from an outgoing side opening. It is also possible to illuminate each of the reflective indicating elements 41(a) to 41(c) with highly uniform luminous flax by using the lighting unit 35 having the optical instruments such as lenses 31, 33, 34 and a prism 36 in combination.

As is known, it is also possible to perform the uniform lighting on each of the reflective indicating elements 41(a) to 41(c) by using a lens array having multiple lenses two-dimensionally placed as the optical instrument which allows the uniform lighting.

Here, an optical system using the lighting unit 35 based on the rod integrator 32 is shown, and the entire optical system of the projection display apparatus will be described.

The light emitted from the extra high pressure mercury lamp 1 as the light generating instrument is collected by a reflector 2 which is a light collecting instrument. In this case, the luminous flax emitted from the opening of the reflector 2 are the luminous flax of uneven brightness with a large luminance difference between a vicinity of the center of the luminous flax and a periphery thereof. Thus, the uniform luminous flax are emitted from the outgoing side opening by the above-mentioned rod integrator 32. The lighting unit 35 causes the luminous flax emitted from rod integrator 32 to propagate the light to the positions at which the reflective indicating elements 41(a) to 41(c) capable of forming an image by light modulation are placed so as to become the luminous flax of an appropriate size to effective areas of the reflective indicating elements 41.

In FIG. 14, the extra high pressure mercury lamp 1 used as a light source is generally an instrument which projects white light. Therefore, if the reflective indicating elements 41(a) to 41(c) are illuminated with the white light as is and the luminous flax modulated by the reflective indicating elements 41(a) to 41(c) are projected on the screen via the projection lens 51, only a black and white, that is, grayscale image is outputted.

Thus, to display a color image, the white light is transmitted through a color separation and composition prism 37 for separating the white light into three primary colors of red, green and blue so as to decompose it into the luminous flax in the three colors. The individual luminous flax are light-modulated by the reflective indicating elements 41(a) to 41(c) respectively, and are then color-composed again to project a color image.

Thus, an image display as a large-screen, bright and highly uniform color image is realized on the screen.

In FIG. 13, the color image is formed by using the color separation and composition prism 37 and the three reflective indicating elements 41(a) to 41(c). As in a configuration example shown in FIG. 14, as for the white light emitted from the extra high pressure mercury lamp 1, the color for illuminating a reflective indicating element 201 is divided at least into the three primary colors in chronological order by having a color separation filter 301 called a color wheel rotated by a color wheel control circuit 303 and a driving instrument 302 to project the image in each of the colors formed by one reflective indicating element 201 on the screen in a period of being illuminated in each of the colors so as to realize the color image. As for this projection display apparatus, an image displayed in a time period for forming one screen (approximately 17 ms) has the light perceived by one's eye recognized for a certain time period even if it is an image displayed in a different color so that an illusion of having the images in different colors simultaneously shining is given so as to allow the color image to be displayed.

It is said that the optical system of FIG. 14 requiring the only one reflective indicating element 201 is lower-cost than the optical system of FIG. 13 requiring the three reflective indicating elements 41(a) to 41(c).

There are also known projection display apparatuses, such as a projection display apparatus using a light-emitting diode instead of the extra high pressure mercury lamp 1 for the conventional optical system and a projection display apparatus for spectrally composing the luminous flax emitted from the extra high pressure mercury lamp and solid state light sources such as a laser light source and the light-emitting diode by using a dichroic filter to illuminate the reflective indicating elements 41(a) to 41(c) and the reflective indicating element 201.

As for the conventional arts relating to this application, Japanese Patent Laid-Open No. 5-346557, Japanese Patent Laid-Open No. 2002-296680 and Japanese Patent Laid-Open No. 2003-302702 are known for instance.

Problems of the conventional examples will be described. In the case of the projection display apparatus for projecting an image formed by small reflective indicating elements by enlarging it with the projection lens, high optical output is required by the light emitted from the light source.

In recent years, most of the projection display apparatuses used for business meetings and small conference rooms are products of 1000-lm or higher brightness. Most of them are using an extra high pressure mercury lamp for emitting light with 100-W or more power consumption and arc discharge between electrodes of 1 mm or so as the extra high pressure mercury lamp 1. As luminous efficiency of the extra high pressure mercury lamp is approximately 60 to 70 lm/W, the brightness of the light emitted from the extra high pressure mercury lamp 1 is apparently 6000 to 7000 lm or so and the optical output of the entire optical system in the projection display apparatus is 1000 lm which is ⅙ to 1/7 of the brightness of the extra high pressure mercury lamp 1.

If an extra high pressure mercury lamp consuming 100 W or more is used in this case, a battery such as a dry battery or a rechargeable battery of a current practical size is mostly used up without lasting for ten minutes when the power is thereby supplied. Thus, it is used by receiving utility power constantly available from an AC outlet or supply of power from a generator operable for a long time. For this reason, there is a problem that a range of use is limited, such as being unusable in a place with no outlet or portability of the projection display apparatus rendered inferior by use of a large generator.

In general, a lamp such as the extra high pressure mercury lamp 1 for emitting the light by the arc discharge has a structure which would have no problem at a temperature close to 1000° C. with a metallic electrode portion and gas around a light-emitting portion in the vessel portion. Therefore, possible supply of power can be increased, and the extra high pressure mercury lamp often used for the projection display apparatus can have high optical output, such as an amount of beams of 6000 to 7000 lm at 100 W from the light-emitting portion arc-discharged in a range of 1 mm or so between the electrodes. However, there is also a drawback that it takes one to two minutes after supplying the power until emitting maximum optical output thereof. This is because, the extra high pressure mercury lamp capable of supplying the power of 100 W or higher in the currently used light-emitting portion of 1 mm or so includes the mercury not evaporated at normal temperature in the vessel, and the mercury encapsulated in the vessel evaporates and flows convectively in the vessel as temperature in the vessel is increased by the arc discharge between electrodes due to the supply of power so that the light is emitted and the brightness is obtained when the evaporated mercury is excited in the arc portion and returns to the ground state. In the case of heat generation by the arc discharge between electrodes of 1 mm or so, it takes one to two minutes for the mercury to evaporate completely while it takes the same time period until the extra high pressure mercury lamp acquires maximum output.

Light-emitting diodes 11(a) to 11(c) emits the light by electrical action in a semiconductor, and so they are characterized by reaching approximately maximum brightness within 1 second upon the supply of power. However, as there is a thermal restriction that junction temperature of a semiconductor junction portion which is a light-emitting portion is 100 to 150° C., maximum possible supply of power is 1 to 5 W or so to an element of 1 mm square even in recent years. Most of them have significantly low power consumption in comparison with the extra high pressure mercury lamp and the like. A green light-emitting diode having the highest luminous efficiency has approximately 40 lm/W, which is 200 lm or so per element and is significantly low in comparison with the extra high pressure mercury lamp of 100 W. Therefore, to obtain the same luminous flax as the extra high pressure mercury lamp of 100 W, it is necessary to use about 30 light-emitting diodes, which renders the area of the light-emitting portion significantly large, renders it impossible to collect all the luminous flax emitted from the light-emitting diodes and renders it difficult to collect many luminous flax emitted from the light-emitting diodes having their light-emitting portions scattered in a wide range so that substantial optical output is reduced.

The present invention has been made in view of such problems, and an object thereof is to realize the projection display apparatus capable of simultaneously obtaining the same brightness as before and necessary output immediately upon the supply of power.

### DISCLOSURE OF THE INVENTION

In order to achieve the above-mentioned object, the 1st aspect of the present invention is a projection display apparatus comprising:

a first light generating instrument which includes a light source that generates white light;

a second light generating instrument which includes a plurality of solid state light sources which generate red, green, and blue monochromatic light respectively;

a light modulation element which modulates the white light when the white light is received and which modulates the monochromatic light when the monochromatic light is received;

a light guiding instrument which switches between guiding the white light and the monochromatic light to the light modulation element; and

a projection instrument which projects the light modulated by the light modulation element.

Further, the 2nd aspect of the present invention is the projection display apparatus according to the 1st aspect of the present invention, comprising a color wheel including first, second and third regions corresponding to red, green, and blue colors respectively, the first, second and third regions circularly arranged in chronological order

Further, the 3rd aspect of the present invention is the projection display apparatus according to the 2nd aspect of the present invention, in which the second light modulation element lights up the solid light sources selectively so that there is a match between a color corresponding to one of the regions of the color wheel located in a light path and the color of the monochromatic light.

Further, the 4th aspect of the present invention is the projection display apparatus according to the 2nd aspect of the present invention, in which the color wheel further includes a region corresponding to white, and stops in a state of having the region corresponding to white located in a light path while the monochromatic light is selected by the light guiding instrument.

Further, the 5th aspect of the present invention is the projection display apparatus according to the 1st aspect of the present invention, wherein:

the light modulation element includes first, second and third light modulation elements provided respectively corresponding to solid state light sources of the monochromatic light; and

the light guiding instrument includes:

a first dichroic filter placed on an optical axis of the white light from the first light modulation element;

a first reflecting mirror placed in front of a light incident side of the first light modulation element, a second dichroic filter placed in front of the light incident side of the second light modulation element, and a second reflecting mirror placed on the optical axis of the light transmitted through the first and second dichroic filters of the light from the first light modulation element; and

a third reflecting mirror placed in front of the light incident side of the third light modulation element.

Further, the 6th aspect of the present invention is the projection display apparatus according to the 1st aspect of the present invention, further comprising:

a control instrument which controls at least operation of the light guiding instrument, and wherein:

the control instrument controls the light guiding instrument to guide the monochromatic light to the light modulation element and further controls the light guiding instrument after a predetermined time to guided the white light to the light modulation element.

Further, the 7th aspect of the present invention is the projection display apparatus according to the 6th aspect of the present invention, wherein:

the control instrument controls the first light generating instrument and the second light generating instrument so that

the second light generating instrument generates the monochromatic light while the light guiding instrument is guiding the monochromatic light to the light modulation element, and

the first light generating instrument generates the white light while the light guiding instrument is guiding the white light to the light modulation element.

Further, the 8th aspect of the present invention is the projection display apparatus according to the 7th aspect of the present invention, wherein:

the control instrument includes a light volume measuring instrument which at least measures a light volume of the first light generating instrument, and controls the light guiding instrument to guide the white light to the light modulation element at the time as the predetermined time, when the light volume measured by the light volume measuring instrument becomes equal to or more than a predetermined value.

Further, the 9th aspect of the present invention is the projection display apparatus according to the 5th aspect of the present invention, further comprising:

collector optics for collecting the white light or the monochromatic light on the light modulation element, and wherein:

the light guiding instrument selectively guides the white light or the monochromatic light to the collector optics and thereby guides the white light or the monochromatic light selectively to the light modulation element.

Further, the 10th aspect of the present invention is the projection display apparatus according to the 9th aspect of the present invention, wherein:

an optical axis of the white light generated by the first light generating instrument between the first light generating instrument and the collector optics is substantially on a straight line; and

the optical axis of the monochromatic light generated by the second light generating instrument between the second light generating instrument and the collector optics is bent via the light guiding instrument.

Further, the 11th aspect of the present invention is The projection display apparatus according to the 9th aspect of the present invention, wherein:

the optical axis of the monochromatic light generated by the second light generating instrument between the second light generating instrument and the collector optics is substantially on a straight line; and

the optical axis of the white light generated by the first light generating instrument between the first light generating instrument and the collector optics is bent via the light guiding instrument.

Further, the 12th aspect of the present invention is the projection display apparatus according to the 7th aspect of the present invention, wherein:

the first light generating instrument is driven by a first power supply based on supply of power from outside;

the second generating instrument is driven by a second power supply which is a built-in power supply;

the control instrument monitors a status of the first power supply and the second power supply;

the control instrument controls the light guiding instrument to guide the monochromatic light to the light modulation element irrespective of the state of the first power supply and the second power supply, and exerts control, on detecting that at least the first power supply is supplied with the power from outside, to operate the second light generating instrument and then the first light generating instrument.

Further, the 13th aspect of the present invention is the projection display apparatus according to the 1st aspect of the present invention, in which the second light generating instrument is a light-emitting diode or a laser diode.

Further, the 14th aspect of the present invention is the projection display apparatus according to the 1st aspect of the present invention, in which the first light generating instrument is a lamp which emits light by arc discharge.

Further, the 15th aspect of the present invention is the projection display apparatus according to the 1st aspect of the present invention, in which the light guiding instrument includes a mirror surface located between the optical axis of the white light and the optical axis of the monochromatic light by rotation or parallel movement.

Further, the 16th aspect of the present invention is an image display method using:

a first light generating instrument which generates white light;

a second light generating instrument which includes a plurality of solid state light sources and thereby generates more than or equal to three kinds of monochromatic light;

a light modulation element which modulates the white light when the white light is received and which modulates the monochromatic light when the monochromatic light is received; and

a projection instrument which projects the light modulated by the light modulation element, and wherein:

the method includes a light guiding step of switching between guiding the white light and the monochromatic light to the light modulation element; and

the light guiding step guides the monochromatic light to the light modulation element and then guides the white light to the light modulation element.

Further, the 18th aspect of the present invention is a recording medium which is recorded a program and processable by the computer, wherein the program is for causing a computer to function as a control instrument which controls at least operation of the light guiding instrument of the projection display apparatus according to the 6th aspect of the present invention.

### BRIEF DESCRIPTION OF THE DRAWINGS

FIG. 1 is a diagram showing an example of a schematic configuration of a projection display apparatus according to a first embodiment of the present invention;

FIG. 2 is a diagram showing an example of the schematic configuration of the projection display apparatus according to the first embodiment of the present invention;

FIG. 3 is a diagram showing an example of the schematic configuration of the projection display apparatus according to the first embodiment of the present invention;

FIG. 4 is a diagram showing an example of the schematic configuration of the projection display apparatus according to the first embodiment of the present invention;

FIG. 5 is a diagram showing an example of an overview of an overall configuration of the projection display apparatus according to a second embodiment of the present invention;

FIG. 6 is a diagram showing an example of a flowchart showing a startup procedure of the projection display apparatus according to the second embodiment of the present invention;

FIG. 7 is a diagram showing an example of the schematic configuration of the projection display apparatus according to a third embodiment of the present invention;

FIG. 8 is a diagram showing an example of the schematic configuration of the projection display apparatus according to the third embodiment of the present invention;

FIG. 9 is a diagram showing an example of a schematic configuration of a color wheel according to the third embodiment of the present invention;

FIG. 10 is a diagram showing an example of the schematic configuration of the color wheel according to the third embodiment of the present invention;

FIG. 11 is a diagram showing an example of the schematic configuration of the projection display apparatus according to the third embodiment of the present invention;

FIG. 12 is a diagram showing an example of a flowchart showing the startup procedure of the projection display apparatus according to the third embodiment of the present invention;

FIG. 13 is a diagram showing an example of the schematic configuration of a conventional projection display apparatus;

FIG. 14 is a diagram showing an example of the schematic configuration of the conventional projection display apparatus; and

FIG. 15 is a diagram showing another example of the schematic configuration of the projection display apparatus according to the first embodiment of the present invention.

### DESCRIPTION OF SYMBOLS

1 Extra high pressure mercury lamp
3 Reflector
3 Lamp unit
11(a), 11(b), 11(c), 111 Light-emitting diodes
12(a) , 12(b) , 12(c) , 112 Collective lenses
13 Cross prism
14, 114 Solid state light source unit
21, 22, 23 Movable mirrors
31 Lens
32 Rod integrator
33 Lens
34 Lens
35 Lighting unit
36 Prism
37 Color separation and composition prism
41(a, 41(b), 41(c) Reflective indicating elements
51 Projection lens
101 Mirror portion adjusting mechanism

### BEST MODE FOR CARRYING OUT THE INVENTION

Embodiments of the present invention will be described below by referring to the drawings.

### FIRST EMBODIMENT

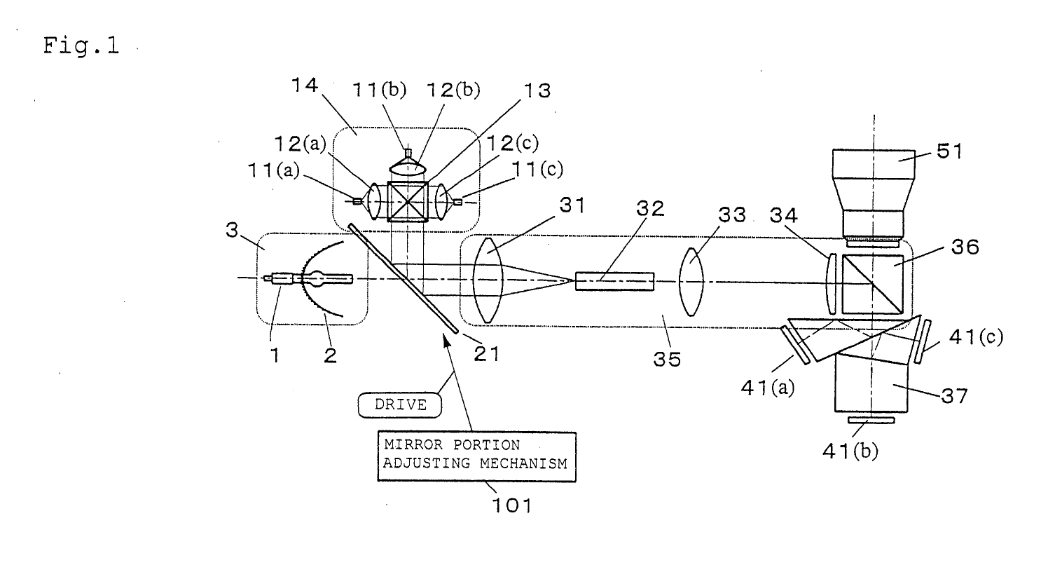

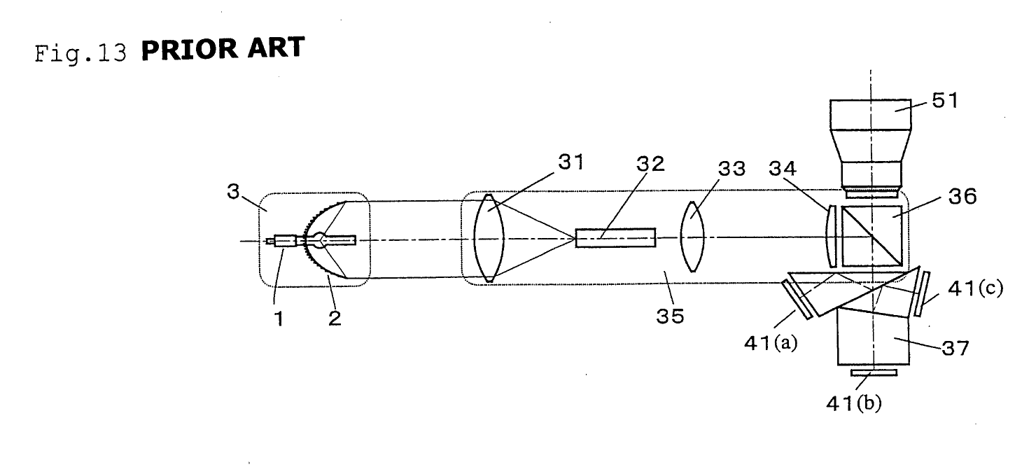

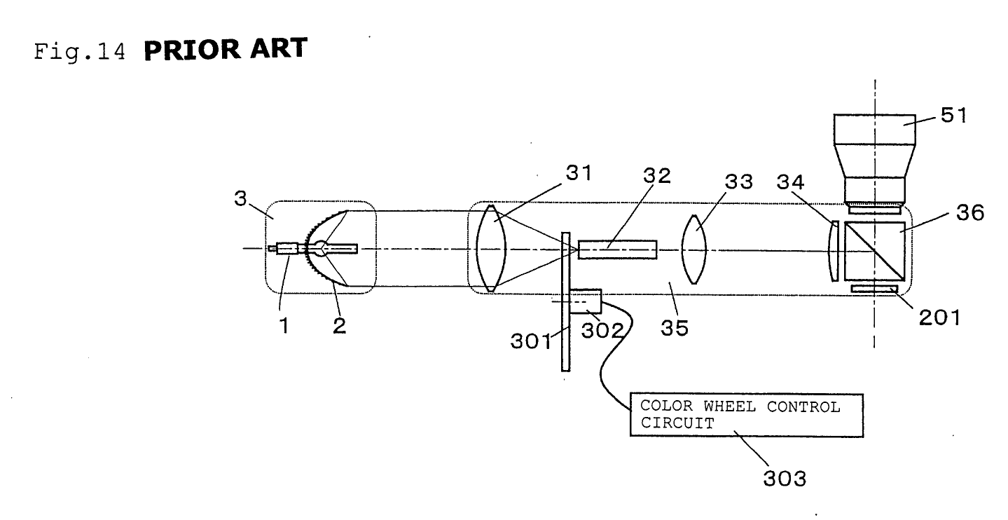

FIG. 1 shows a schematic configuration of a projection display apparatus according to the first embodiment. The portions that are the same as or equivalent to those of a conventional projection display apparatus shown in FIGS. 13 and 14 are given the same symbols.

FIG. 1 shows an configuration composed of a lamp unit 3 including an extra high pressure mercury lamp 1 and a parabolic mirror 2, a solid state light source unit 14 including light-emitting diodes 11(a) to 11(c) and corresponding lenses 12(a) to 12(c), a lighting unit 35 using lenses 31, 33 and 34 for allowing luminous flax to be formed and uniformized according to a lighting area, and a rod integrator 32 for allowing highly uniform lighting, a movable mirror 21 capable of switching the luminous flax entering the lighting unit 35, reflective indicating elements 41(a) to 41(c) as light modulation elements for modulating illumination light and a projection lens 51.

In the configuration, the lamp unit 3 is equivalent to a configuration including a first light modulation element of the present invention, and the extra high pressure mercury lamp 1 is equivalent to a light source utilizing discharge of the present invention. The solid state light source unit 14 is equivalent to a configuration including a second light generating instrument of the present invention, and the light-emitting diodes 11(a) to 11(c) are equivalent to solid state light sources of the present invention. The lenses 31, 33 and 34, a prism 36 and the rod integrator 32 constitute collection optics of the present invention. The reflective indicating elements 41(a) to 41(c) are equivalent to the light modulation elements of the present invention, and the projection lens 51 is equivalent to a projection instrument of the present invention. The movable mirror 21 and a mirror portion adjusting mechanism 101 are equivalent to light guiding instruments of the present invention.

In the configuration, it is also possible to use a lamp such as a xenon lamp having inactive gas or the like encapsulated in a glass tube and an emitter formed by arc discharge or a metal halide lamp of good luminous efficiency instead of the extra high pressure mercury lamp 1. It is also possible to use a lamp such as a krypton lamp or a halogen lamp which emits light by energizing a filament.

It is also possible, instead of using the parabolic mirror 2, to use a reflector such as an ellipsoidal mirror of which collection state of emitted luminous flax is different in order to match with an optical system on the lighting unit 35 side.

It is also possible, instead of using the light-emitting diodes 11(a) to 11(c), to use a semiconductor laser of which material is the same semiconductor, a solid state laser such as an Nd: YAG laser or a gas laser such as an Ar laser.

In this case, to obtain the same white light as the above-mentioned extra high pressure mercury lamp 1 from the light-emitting diode which emits monochromatic light and the like, the light emitted from three kinds of light-emitting diode of red, green and blue (the light-emitting diodes 11(a) to 11(c) emits monochromatic light respectively) should be combined as shown in FIG. 1. As is also known, it can also be obtained by a method of emitting the light of which wavelength is close to ultraviolet light or in a region of UV wavelengths and combining lights emitted from fluorescent materials glowing in red, green and blue when the light of that wavelength enters, and a method of combining a light emitted from the light-emitting diode which emits blue light with a light emitted from the fluorescent material for glowing in yellow or glowing in green or red when the blue light enters.

It is also possible to obtain the white light from another solid state light source by using the same method.

This embodiment shows a configuration in which the light in red, green and blue emitted from the light-emitting diodes 11(a) to 11(c) is color-composed by a composition instrument such as a cross prism 13 so that the luminous flax emitted from the solid state light source unit 14 become the white light.

In this case, it may be composed of a monochromatic light-emitting diode having the light-emitting diode which emits the light close to ultraviolet light or in the region of the UV wavelengths and the fluorescent materials glowing in red, green and blue when the light of that wavelength enters placed in proximity of a light-emitting portion of the light-emitting diode and housed in the same package.

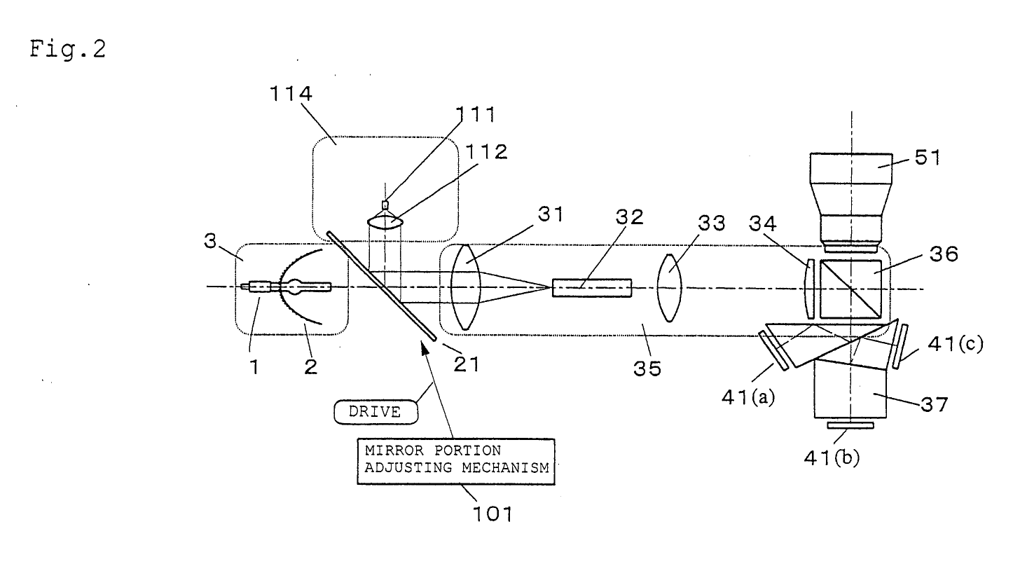

Furthermore, as illustrated in the configuration example shown in FIG. 2, it may be composed of a white light-emitting diode 111 having a light-emitting diode which emits the blue light and a fluorescent material for glowing in yellow when the blue light enters placed in proximity of a light-emitting portion of the light-emitting diode and housed in the same package or the white light-emitting diode 111 having the light-emitting diodes of red, green and blue housed in the same package.

The lenses 12 are used to collect the luminous flax emitted from the light-emitting diodes 11 on the lighting unit 35, and may be an optical instrument using the reflector instead of the lenses or both the reflector and lenses.

A description will be given as to operation of the projection display apparatus having the above configuration according to the embodiment of the present invention, whereby an embodiment of an image display method of the present invention will be described by referring to FIG. 1.

FIG. 1 shows the case of using the luminous flax emitted from the solid state light source unit 14 for lighting of the reflective indicating elements 41(a) to 41(c) . In the solid state light source unit 14, the luminous flax in three colors of the light-emitting diodes 11(a) to 11(c) collected by using the lenses 12(a) to 12(c) are color-composed by the cross prism 13 so as to enter the lighting unit 35 as the white light via the movable mirror 21. In this case, the movable mirror 21 should be moved to a position where most of the luminous flax emitted from the solid state light source unit 14 enter the lighting unit 35. Thus, an optical axis of the light emitted from the solid state light source unit 14 and reaching the lighting unit 35 is orthogonally bent by the movable mirror 21.

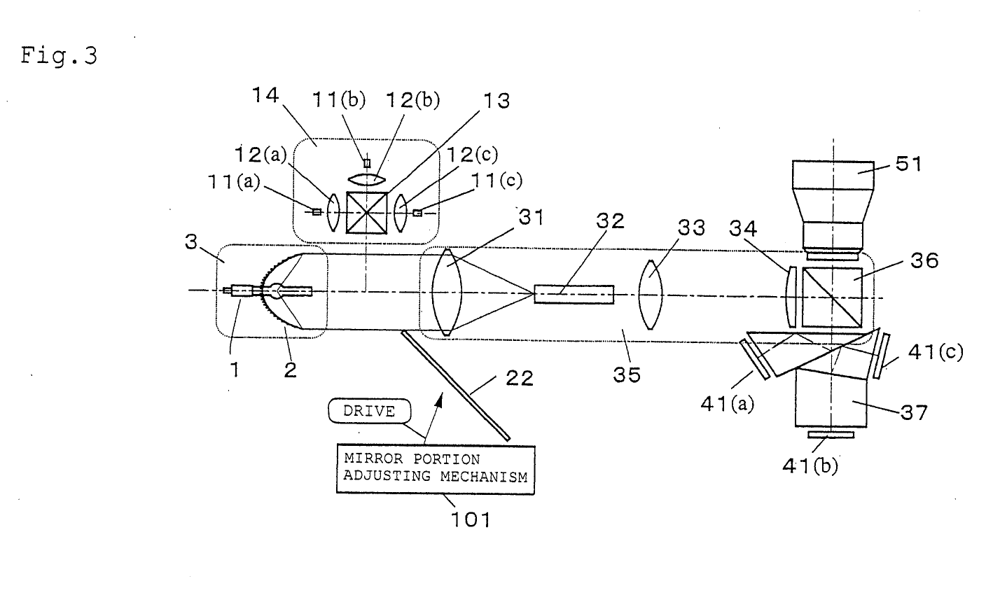

In the case of using the luminous flax emitted from the extra high pressure mercury lamp 1 for lighting of the reflective indicating elements 41(a) to 41(c), the luminous flax efficiently collected by using the parabolic mirror 2 enter the lighting unit 35 without being blocked by the movable mirror 21 as shown in FIG. 3. In this case, the movable mirror 21 is moved by the operating mirror portion adjusting mechanism 101 to a position in which most of the luminous flax emitted from the lamp unit 3 side are not blocked.

Thus, it is possible, with the movable mirror 21 which is simple, to select the luminous flax entering the lighting unit 35 side from two light source apparatuses of the solid state light source unit 14 and lamp unit 3.

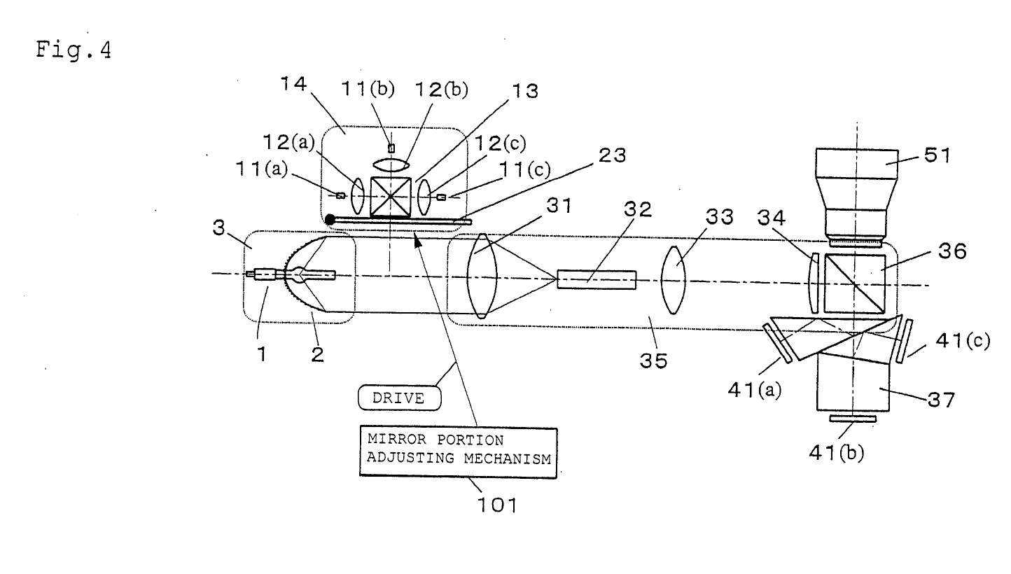

FIG. 3 shows a configuration in which the luminous flax are selected by having a movable mirror 22 for selecting the light source apparatus for entering the lighting unit 35 slid in parallel with a mirror plane by the mirror portion adjusting mechanism 101. In the case of having the luminous flax of the lamp unit 3 enter the lighting unit 35 side as in FIG. 4, the movable mirror 21 may be arranged to rotatively move with one side of a movable mirror 23 as a rotation axis (indicated by a black circle in the drawing) so as to place the movable mirror 21 at a predetermined angle at which the luminous flax emitted from the lamp unit 3 are not blocked.

To be more specific, any configuration may be used to allow for switching the luminous flax from the lamp unit 3 and the luminous flax from the solid state light source unit 14 to the luminous flax entering the lighting unit 35 by using the light guiding instruments such as the movable mirror 21, as described above.

The movable mirror 21 is operated by the mirror portion adjusting mechanism 101. The adjusting mechanism portion may be arranged to be either manually driven or automatically driven by a driving circuit using a motor or the like.

Next, a description will be given as to the lighting unit 35 to the projection lens 51.

Incident light selected according to the position of the movable mirror 21 is collected by the lens 31, and illuminates the three reflective indicating elements 41(a) to 41(c) via the lighting unit 35 composed of the optical instruments such as a glass column, the rod integrator 32 like a hollow cylinder composed of bonded mirrors, a lens 33 and a color separation and composition prism 37 for separating a white light source emitted from the light source apparatuses into three primary colors. The light modulated by the three reflective indicating elements 41 are color-composed again by the color separation and composition prism 37 and projected on the screen via the projection lens 51 so as to project an enlarged color image.

In the configuration, a reflection loss of the light occurs when reflecting the light on the movable mirror 21 in the case of having the light enter the lighting unit 35 side via the movable mirror 21.

Thus, according to this embodiment, maximum output of the projection display apparatus is increased by placing the light source apparatus for generating the largest possible volume of the luminous flax on a light path side allowing the light to enter the lighting unit 35 without being reflected by the movable mirror 21.

If this case is considered by using both the light sources of this time, they should be placed as in FIG. 1, where the lamp unit 3, not via the movable mirror 21, uses as its light source the extra high pressure mercury lamp 1 having high luminous efficiency of 60 to 70 lm/W and capable of the optical output of 6000 to 7000 lm by supply of power of 100 W rather than the solid state light source unit 14 using the light-emitting diodes, that is, the optical axis having the outgoing light from the lamp unit 3 between itself and the lighting unit 35 is a straight line on the light path side.

In the case where it is desirable to obtain as high optical output as possible with the lowest possible power consumption, however, it is preferable to place them to have the luminous flax emitted from the light source apparatus of low power consumption on the light path side not via the movable mirror 21. If this case is considered by using both the light sources of this time, the solid state light source unit 14 is apt to be less power-consuming since it uses as its light source the light-emitting diodes 11(a) to 11(c) with the maximum power consumption per element of 1 to 5 W which is much smaller than the extra high pressure mercury lamp 1 capable of high optical output by supply of power of 100 W. Therefore, the solid state light source unit 14 should be placed not via the movable mirror 21 so that the lamp unit 3 and solid state light source unit 14 of FIG. 1 switch their positions (not shown), that is, the optical axis having the outgoing light from the solid state light source unit 14 between itself and the lighting unit 35 is a straight line on the light path side.

In view of the size and design of the entire projection display apparatus, it is also possible to switch the positions of the lamp unit 3 and the solid state light source unit 14 so that, in the case of having the luminous flax emitted from the lamp unit 3 enter the lighting unit 35, they enter via the movable mirror 21 so as to have the luminous flax emitted from the solid state light source unit 14 directly enter the lighting unit 35.

As described regarding the conventional examples, the extra high pressure mercury lamp having the light-emitting portion of 1 mm or so and capable of supply of power of 100 W or more used in the projection display apparatus of approximately 1000-lm brightness includes the mercury not evaporated at normal temperature in the vessel. In the case of the arc discharge between the electrodes of 1 mm or so, there is a problem that it takes one to two minutes for the mercury to evaporate before the maximum output is obtained.

The light-emitting diode has an advantage that its power consumption is 5 W or so which is smaller and approximately maximum output is emitted within 1 second from the supply of power. There is a problem, however, that in the case of using the one having the light-emitting portion of 1 mm square as with the extra high pressure mercury lamp, the light emitted from the light-emitting portion is 100 lm or so, which can not produce the brightness required for business meetings and small conference rooms.

To cope with such problems, the projection display apparatus of this embodiment has the movable mirror 21 placed in the light path of the solid state light source unit 14 after the main power of the projection display apparatus is turned on. And both the light sources of the extra high pressure mercury lamp 1 and light-emitting diodes 11(a) to 11(c) are lit up.

After a predetermined sufficient light volume as a predetermined value of the present invention is attained by the light volume emitted from the lamp unit 3 using the extra high pressure mercury lamp 1 of the arc discharge which takes time before reaching sufficient brightness after the supply of power or estimated time for reaching that volume elapses, the movable mirror 21 in the light path is moved to switch it so as to have the luminous flax emitted from the lamp unit 3 enter the lighting unit 35. The light-emitting diodes 11(a) to 11(c) are turned off thereafter.

This series of operations allows a projected image to be displayed by instantaneous lighting of the light-emitting diodes 11(a) to 11(c) capable of approximately maximum optical output within 1 second upon turning on the main power of the projection display apparatus. Furthermore, if predetermined time elapses from the turn-on of the main power, a larger and brighter projected image can be displayed by the extra high pressure mercury lamp 1 capable of high output. The “predetermined light volume” may be decided by rating of the light-emitting diode, the light volume according to actual measurement and the like. The estimated time is an example of the predetermined time of the present invention, where it is possible to use either an actual measurement value of the time it takes until the extra high pressure mercury lamp 1 emitting light in advance reaches the light volume as-is as a fixed value or the time it takes until a value measured by a light volume sensor not shown reaches the actual measurement value.

According to the above description, there is a period in which the light-emitting diodes 11(a) to 11(c) and the extra high pressure mercury lamp 1 are simultaneously lit up. However, the light guided into the lighting unit 35 by the movable mirror 21 is limited to that emitted from one of them, and so both of them are not simultaneously emitted to the lighting unit 35 via the movable mirror 21. This has the following reason: In the case of combining the monochromatic light of the extra high pressure mercury lamp and the solid state light sources such as the semiconductor laser and light-emitting diodes by means of a dichroic filter, there is a problem that, of a continuous spectrum of the extra high pressure mercury lamp, the light of a wavelength region corresponding to the spectrum of the solid state light sources is eliminated by the filter to spectrally compose the luminous flax of the semiconductor laser and light-emitting diodes so that an absolute light volume does not increase so much even if combined.

Furthermore, the dichroic filter is an optical component having a dielectric body multilayer-coated in this case, where accuracy of a cutoff wavelength of which transmission spectrum is significantly variable has individual differences in order of 5 to 10 nm. Therefore, there is a problem that, as a spectral width of the extra high pressure mercury lamp to be eliminated by the dichroic filter must be taken by a large amount to securely combine it with the light from the solid state light sources, use efficiency of the luminous flax emitted from the extra high pressure mercury lamp is significantly reduced.

Therefore, the present invention avoids these problems and secures sufficient use efficiency of the luminous flax.

As described above, it is possible, by using the configuration of the present invention, to realize the projection display apparatus having the effects of allowing the instantaneous lighting upon the supply of power and obtaining the high optical output as before if time elapses.

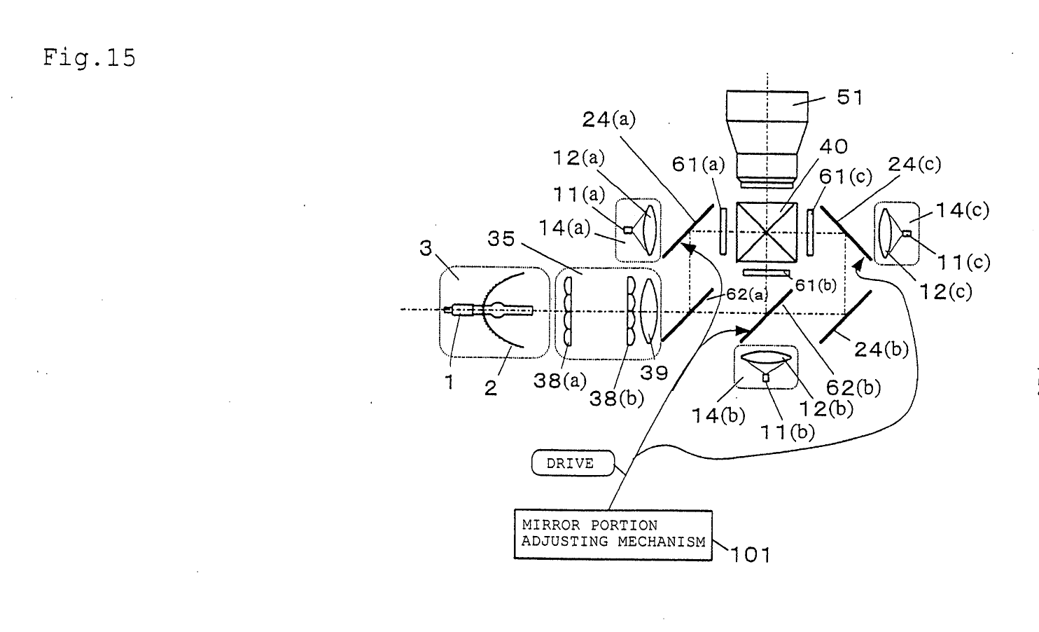

It is also possible to use three transmissive indicating elements 61(a) to 61(c) as the light modulation elements provided correspondingly to the colors of the light-emitting diodes 11(a) to 11(c) instead of the reflective indicating elements 41(a) to 41(c). FIG. 15 is a block diagram in the case of using the transmissive indicating elements. As shown in FIG. 15, it is possible, without color-composing the light from the light-emitting diodes 11(a) to 11(c), to have the light directly enter the transmissive indicating elements 61(a) to 61(c) respectively.

In this case, the solid state light source unit is composed of three solid state light source units 14(a) to 14(c) corresponding to the light-emitting diodes 11(a) to 11(c) respectively. As for the light guiding instruments, three reflecting mirrors of reflecting mirrors 24(a), 24(c) placed in front of the incident sides of the transmissive indicating elements 61(a), 61(c) respectivelyandareflectingmirror24(b) placed on the optical axis of the outgoing light from the lamp unit 3 and two dichroic filters of a dichroic filter 62(a) placed on the optical axis of the outgoing light from the lamp unit 3 and a dichroic filter 62(b) placed in front of the incident side of the transmissive indicating element 61(b) are used and controlled respectively. Therefore, there is no need to provide the collection optics such as the lighting unit 35 at least between the solid state light source unit and the transmissive indicating elements 61(a) to 61(c) . In this configuration, instead of the color separation and composition prism 37, a cross prism 40 is used for the sake of color-composing the light color-separated by the reflecting mirrors 24(a) to 24(c) and dichroic filter 62(a), 62(b) and emitted from the lamp unit 3 or the solid state light source units 14(a) to 14(c) and then light-modulated after being transmitted through the transmissive indicating elements 61(a) to 61(c).

Thus, the configuration such as the cross prism 13 of FIG. 1 becomes no longer necessary in the solid state light source units 14(a) and 14(b), and so there is an advantage that it leads to simplification of the entire optical system of the projection display apparatus. FIG. 15 shows a configuration using lens arrays 38(a), 38(b) and a lens 39 as the lighting unit 35 instead of the lens 31 and rod integrator 32.

In the configuration shown in FIG. 15, the lighting unit 35 does not constitute the collection optics of the present invention. In short, the present invention should have the configuration in which the light from the first light generating instrument included in the lamp unit 3 and the second light generating instrument included in the solid state light source units 14 or 14(a) to 14(c) is led to the light modulation elements implemented selectively as the transmissive indicating elements 61(a) to 61(c) or the reflective indicating elements 41(a) to 41(c), which is not limited by whether or not there is an optical configuration such as the collection optics between the first and second light generating instruments and the light modulation elements.

### SECOND EMBODIMENT

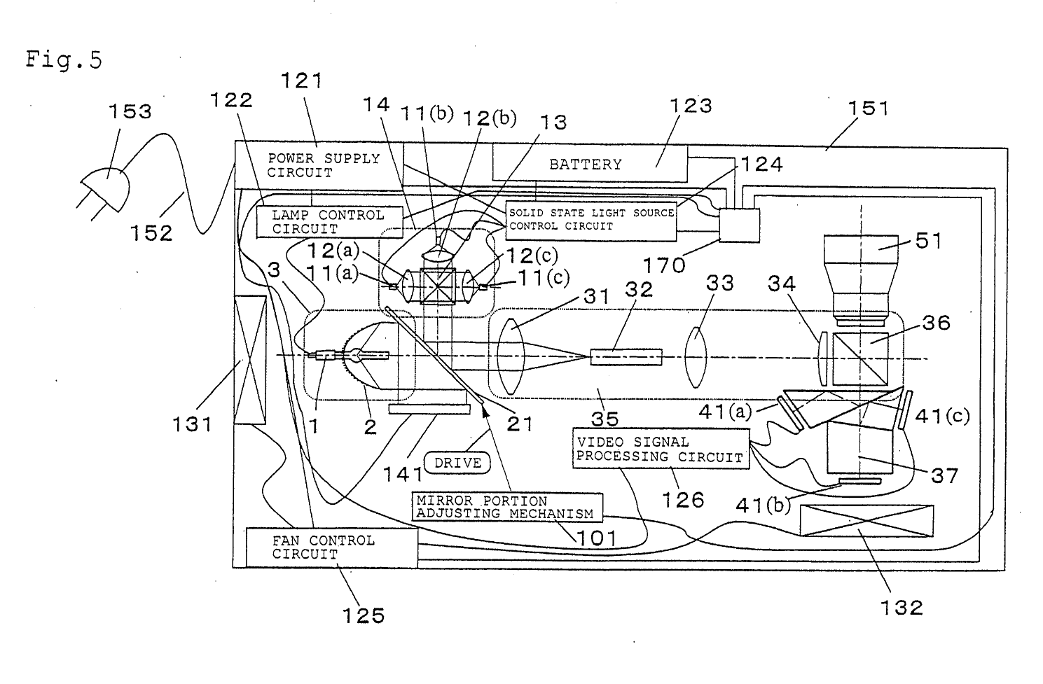

FIG. 5 shows a schematic overall block diagram of a projection display apparatus 151 including a power supply for driving the lamp unit 3 and the like as to the projection display apparatus of the first embodiment.

In FIG. 5, the portions that are the same as or equivalent to those of FIGS. 1 to 4 are given the same symbols, and a detailed description thereof will be omitted. However, both sides of the movable mirror 21 are reflecting surfaces which can reflect both the light from the lamp unit 3 and the solid state light source unit 14 in the placement in FIG. 5. A power supply circuit 121 is an instrument which supplies the power to the lamp unit 3/a lamp control circuit 122 and a fan control circuit 125/cooling fans 131, 132, the lamp control circuit 122 is an instrument which controls on/off of the optical output and the light volume of the lamp unit 3, a battery 123 is an independent built-in power supply of the projection display apparatus 151 and is an instrument which supplies the power to the solid state light source unit 14 and a solid state light source control circuit 124, and the solid state light source control circuit 124 is an instrument which controls on/off and the light volume of the light-emitting diodes 11(a) to 11(c) in the solid state light source unit 14 collectively or individually.

The fan control circuit 125 is an instrument which controls the operations of the cooling fan 131 for cooling the lamp unit 3 and the cooling fan 132 for cooling the reflective indicating elements 41(a) to 41(c), and a video signal processing circuit 126 is an instrument which drives the reflective indicating elements 41(a) to 41(c) by means of significant video signals. A power supply line 152 has its one end connected to an AC outlet 153, and is an instrument which leads the supply of power from outside to the power supply circuit 121. A light volume sensor 141 is an instrument which measures the light volume of the light emitted from the lamp unit 3 and reflected by the movable mirror 21.

A control circuit 170 is an instrument driven by both the utility power and battery 123, which automatically monitors and controls the operations of the lamp control circuit 122, solid state light source control circuit 124, fan control circuit 125 and mirror portion adjusting mechanism 101 based on a user input and/or detected values from the light volume sensor 141. In the configuration, the power supply circuit 121 is equivalent to a first power supply of the present invention while the battery 123 is equivalent to a second power supply of the present invention, and the mirror portion adjusting mechanism 101 and control circuit 170 constitute the control instrument of the present invention. The light volume sensor 141 is equivalent to a light volume measuring instrument of the present invention.

A description will be given below as to the operation of the projection display apparatus 151 having the above configuration according to the second embodiment of the present invention.

First, in the case where brightness is not required so much by the projected image, only the light-emitting diodes 11(a) to 11(c) of which power consumption per element is low are lit up, and the extra high pressure mercury lamp 1 is not lit up. The movable mirror 21 is placed in the light path of the solid state light source unit 14 in order to have the luminous flax emitted from the solid state light source unit 14 enter the lighting unit 35. Thus, the luminous flax emitted from the projection lens 51 become the luminous flax from the solid state light source unit 14. In this case, it requires less power consumption though it is not brighter than the case where the extra high pressure mercury lamp 1 of the arc discharge is lit up. This situation is leveraged to drive the apparatus with the battery 123 so as to use the apparatus as a cordless projection display apparatus 151 without the power supply line 152 for connecting the AC outlet 153 to a housing of the projection display apparatus.

In the case where the brightness is required by the projected image, the power is supplied from outside by using the power supply line 152 for connecting the AC outlet 153 to a housing of the projection display apparatus, and the extra high pressure mercury lamp 1 capable of obtaining high optical output with higher power consumption is lit up. And the movable mirror 21 is eliminated from the light path of the lamp unit 3 to have the luminous flax emitted from the lamp unit 3 enter the lighting unit 35. It is thereby possible to render the luminous flax emitted from the projection lens 51 as the luminous flax emitted from the lamp unit 3 so as to use the projection display apparatus 151 as the one capable of high optical output.

Thus, it is possible to carry it freely in a state of having the light sources lit up cordlessly in the case where the brightness is not required so much by the projected image, and it is possible to obtain the high optical output as before in a situation where there is no need to carry it freely and the power can be supplied from an external AC power supply. It is possible, in such a form, to realize the projection display apparatus 151 having the effects of allowing portability by rendering it cordless by means of battery driving and obtaining the high output as before in the case where the power can be supplied from the AC power supply.

As for the battery 123 for driving the solid state light source unit 14, various rechargeable batteries and power-generating batteries may be used, such as a dry battery like an alkaline battery or a manganese battery, a rechargeable battery like a lithium-ion battery, a nickel-mercury battery or a nickel-cadmium battery, and a fuel battery like a methanol fuel cell or a polymer electrolyte fuel cell.

Next, a description will be given as to control operation of the control circuit 170 for the sake of power saving by the projection display apparatus 151.

As described in the first embodiment, the projection display apparatus 151 is operated by the battery 123 for a while after the turn-on of the main power, and so the extra high pressure mercury lamp 1 is not lit up. Therefore, the control circuit 170 controls the fan control circuit 125 based on an operating state (unlit) of the extra high pressure mercury lamp 1 and thereby limits or stops the supply of power to the fan 131 for mainly cooling the extra high pressure mercury lamp 1 or limits or stops the supply of power to the fan 132 for mainly cooling the reflective indicating elements 41(a) to41(c) configured to accommodate the light volume emitted from the extra high pressure mercury lamp 1. It is thereby possible to reduce the power consumption of the entire projection display apparatus 151 so as to have the effect of extending the time capable of projection with the solid state light source unit 14.

Furthermore, regarding the video signal processing circuit 126, it is possible to have the power supplied only for input signal processing necessary for display and thereby reduce the power consumption of the entire projection display apparatus 151 so as to have the effect of extending the time capable of projection with the solid state light source unit 14.

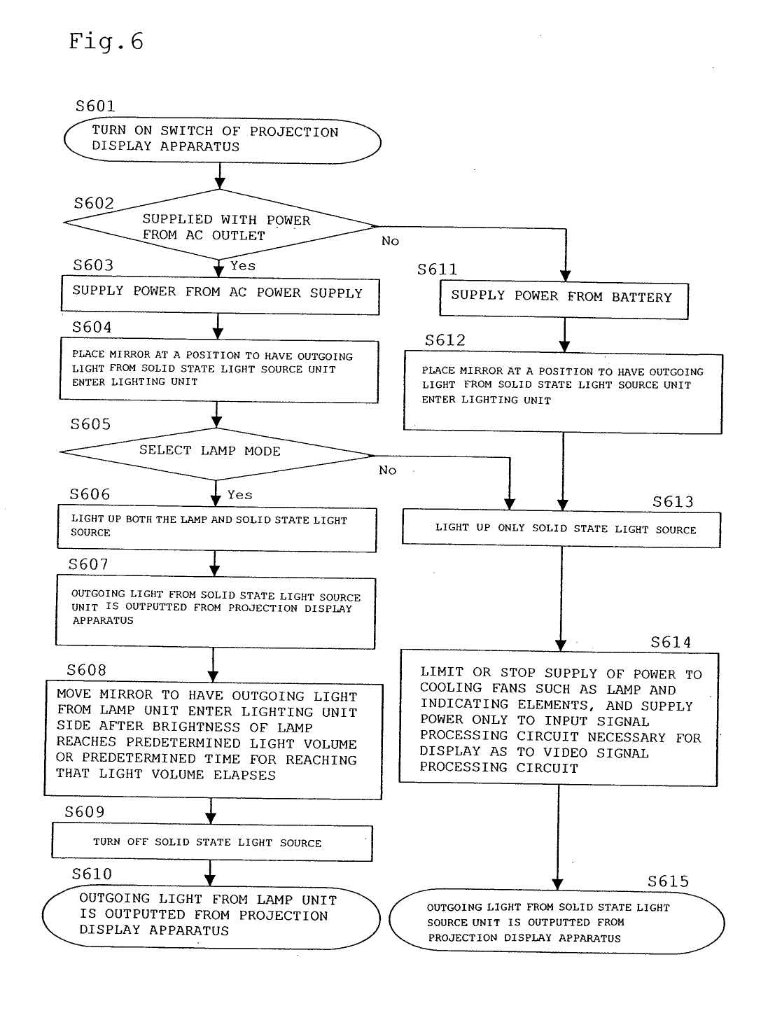

Next, a description will be given by referring to FIG. 6 as to control of the startup procedure of the projection display apparatus having significant effects in the case of using the projection display apparatus 151 as previously described.

First, a main power switch (not shown) of the projection display apparatus 151 is turned on (S601).

And it is determined by referring to the state of the power supply circuit 121 whether or not the projection display apparatus 151 is supplied with the power from the AC outlet 153 (S602). In this case, the procedure thereafter is different between the case of being supplied with the power from the AC power supply (S603) and the case of being supplied with the power from the battery 123 (S611).

In the case where the power is supplied from the AC power supply, the movable mirror 21 is placed at a position to have the outgoing light from the solid state light source unit 14 enter the lighting unit 35 (S604).

In the case of supplying the power from the AC power supply in particular, it is selectable by a user whether to display a bright projected image by using the extra high pressure mercury lamp 1 (lamp mode) or display the projected image by using the light-emitting diodes 11(a) to 11(c) (solid state light source mode) for the sake of reducing the power consumption (S605). In the case where the lamp mode for using the extra high pressure mercury lamp 1 is selected for instance, both the extra high pressure mercury lamp 1 and light-emitting diodes 11(a) to 11(c) are lit up (S606).

In this case, the movable mirror 21 is placed at the position to have the outgoing light from the solid state light source unit 14 enter the lighting unit 35 in a preceding stage, and so the outgoing light from the light-emitting diodes 11(a) to 11(c) as the light source of the solid state light source unit 14 is emitted from the projection lens 51 first (S607).

And it is checked that the brightness of the extra high pressure mercury lamp 1 has reached a predetermined light volume by becoming larger than the light volume emitted from the light-emitting diodes 11(a) to 11(c) or reaching predetermined brightness of the light emitted from the extra high pressure mercury lamp 1. Or else, estimated time for reaching the predetermined light volume is measured in advance, and the movable mirror 21 is moved to have the outgoing light from the lamp unit 3 enter the lighting unit 35 side after the estimated time for reaching the predetermined brightness elapses from lighting of the extra high pressure mercury lamp 1 or switch-on of the projection display apparatus 151 (S608). According to this embodiment, the estimated time is the time until the light volume as the actual measurement value measured by the light volume sensor 141 reaches the fixed value measured in advance and preset in the control circuit 170.

After the light entering the lighting unit 35 side becomes only the luminous flax of the extra high pressure mercury lamp 1 of the lamp unit 3, the light-emitting diodes 11(a) to 11(c) of the solid state light source unit 14 are turned off (S609).

Thus, even in the case where the power is supplied from the external AC power supply and the lamp mode is selected according to this work procedure, it has the effect of obtaining the same bright projected image as before by means of the extra high pressure mercury lamp 1 while allowing the instantaneous lighting (S610).

Next, a second example will be described. In the case where the main power switch of the projection display apparatus 151 is turned on in a state of having no utility power supplied from the AC outlet 153, it is detected that the power is supplied from the battery 123 (S611). And first, the movable mirror 21 is placed at the position to have the outgoing light from the solid state light source unit 14 enter the lighting unit 35 (S612).

In this case, only the light-emitting diodes 11(a) to 11(c) are lit up with the extra high pressure mercury lamp 1 turned off (S613).

In the case where the power is supplied from the AC power supply and the lamp mode is not selected (S605), only the light-emitting diodes are lit up with the extra high pressure mercury lamp 1 turned off likewise (S613).

In the case where the power is supplied from the battery 123, only the light-emitting diodes 11(a) to 11(c) are lit up in order to save power as the projection display apparatus 151 on the whole. Therefore, it limits or stops the supply of power to the cooling fans 131, 132 for mainly cooling the extra high pressure mercury lamp 1 and the reflective indicating elements 41(a) to 41(c) by the control of the fan control circuit 125, and also has only minimum power necessary for display supplied to the video signal processing circuit 126 (S614).

Thus, in the case where the power is supplied from the battery 123 according to this work procedure, it has the effects of allowing the power consumption to be further reduced and allowing the image to be projected by the solid state light source unit 14 for a long time (S615).

It has been described that the items to be determined indicated in the work procedure are handled by the control circuit 170 in the projection display apparatus 151. However, they may be determined automatically by software (a program) . It is also possible for the user to make determinations and have the control circuit 170 operate as an interface for receiving them.

As for movement of the movable mirror 21 indicated in the work procedure, the mobile mirror portion adjusting mechanism 101 with a motor which is automatically drivable is moved automatically by the software (program) as the control circuit 170. However, it may also be moved manually.

As for turn-on and turn-off of the light sources indicated in the work procedure, they are controlled by the lamp control circuit 122 and solid state light source control circuit 124. However, they may be turned on and off automatically by the software (program) or turned on and off manually by the user.

FIG. 1 shows the three lenses of lenses 31, 33 and 34, the rod integrator 32 and the prism 36 as the lighting unit 35. FIG. 1 also shows the lens in the light path and the prism for bending the light path as the optical instruments which convert the light having entered into the lighting unit 35 shown in the lighting unit 35 to illuminating light having the form and uniformity in accordance with the size to be lit on the reflective indicating elements 41(a) to 41(c) side to be lit. However, the lighting unit 35 may be an optical system including the optical instruments such as the one without lenses or the one combining multiple lenses or mirrors and the like not shown.

Furthermore, FIG. 1 shows the configuration using the rod integrator 32 as the optical instrument which allows uniform lighting of the lighting unit 35. However, it may also be the configuration using the lens array having multiple lenses two-dimensionally placed.

Furthermore, the projection display apparatus 151 uses the reflective indicating elements 41(a) to 41(c) as image display elements. However, it may also be the projection display apparatus composed of the transmissive indicating elements or indicating elements such as DMD (Digital Micro-mirror Device) capable of changing a reflecting direction with minute mirrors arranged like an array.

Furthermore, according to the description, the projection display apparatus 151 uses one monochromatic piece of each of the light-emitting diodes 11(a) to 11(c) as the solid state light source, which is minimal. However, it is not limited to one monochromatic piece of each but may also be the projection display apparatus composed of multiple light-emitting diodes.

Furthermore, as in FIG. 1, the projection display apparatus 151 is shown as one lamp unit 3 using the extra high pressure mercury lamp for an arc discharge lamp and one solid state light source unit 14 using the light-emitting diodes as the solid state light source. However, it is not limited to one piece of each but may also be the projection display apparatus composed of multiple lamp units 3 and multiple solid state light source units 14.

### THIRD EMBODIMENT

A third embodiment of the present invention will be described by referring to the drawings.

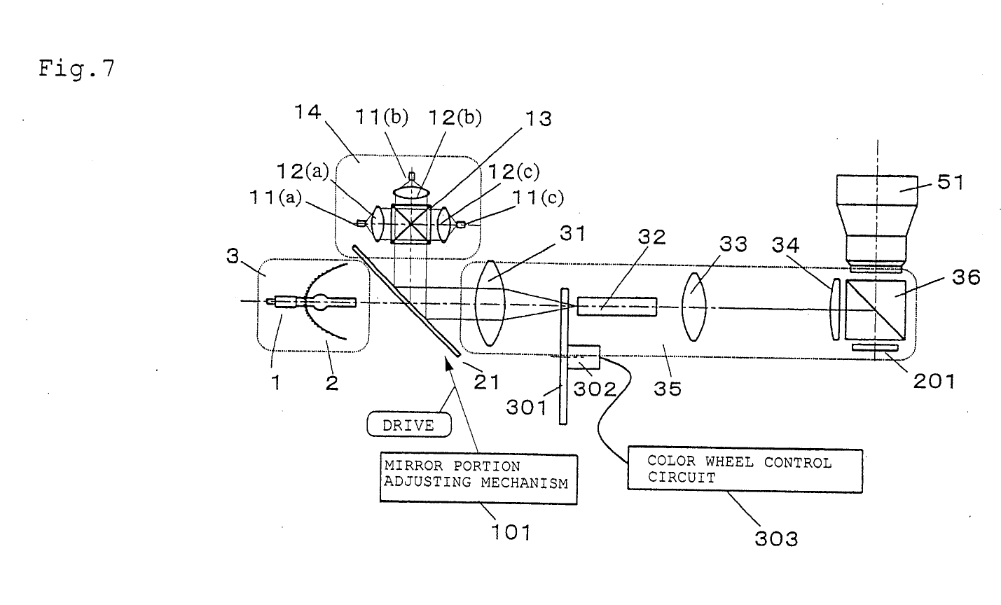

FIG. 7 shows the schematic configuration of the projection display apparatus according to the third embodiment of the present invention. The portions that are the same as or equivalent to those of FIG. 1 are given the same symbols, and a detailed description thereof will be omitted.

The first embodiment shown in FIG. 1 and this embodiment are basically the same. However, there are the following differences: As shown in FIG. 7, this embodiment is different in that it has one reflective indicating element 201 as the light modulation element instead of three and has a color wheel 301 placed in front of the rod integrator 32 to pass through the light path, a driving motor 302 for rotating the color wheel 301 and a color wheel control circuit 303 added thereto instead of the color separation and composition prism 37 in front of the reflective indicating element 201.

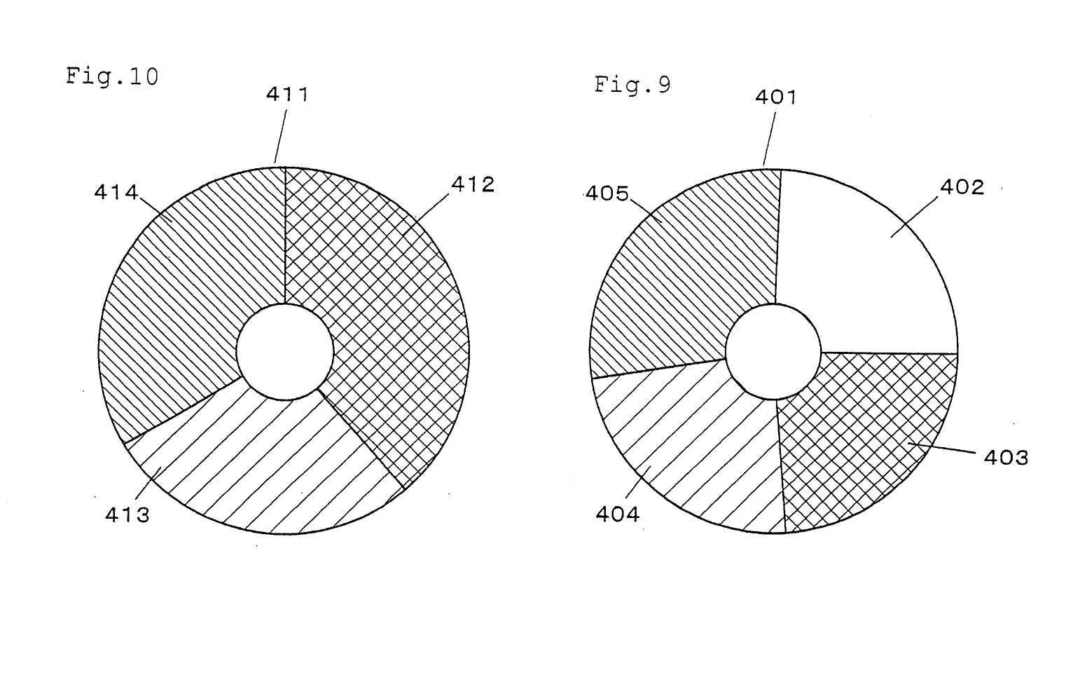

FIGS. 9 and 10 show concrete examples of the color wheel 301. A color wheel 401 shown in FIG. 9 has regions 403 to 405 of a circle colored correspondingly to the three primary colors of light respectively and a transparent region 402. If the driving motor 302 rotates, the light path passes through the regions 402 to 405. A color wheel 411 shown in FIG. 10 has no transparent region, and has only regions 412 to 414 colored correspondingly to the three primary colors of light respectively.

As the color wheel 301 is rotated, a ray of light illuminating the reflective indicating element 201 is dividedly colored in chronological order. In the period when the lighting is performed by the light in each of the colors, the image in each of the colors formed by the one reflective indicating element 201 is projected on the screen so as to realize the color image.

This projection display apparatus causes an illusion that the images in different colors are simultaneously shining to display the color image, because the light perceived by one's eye is recognized for a certain time period even if an image displayed within a time period for forming one screen (approximately 17 ms) is displayed in a different color.

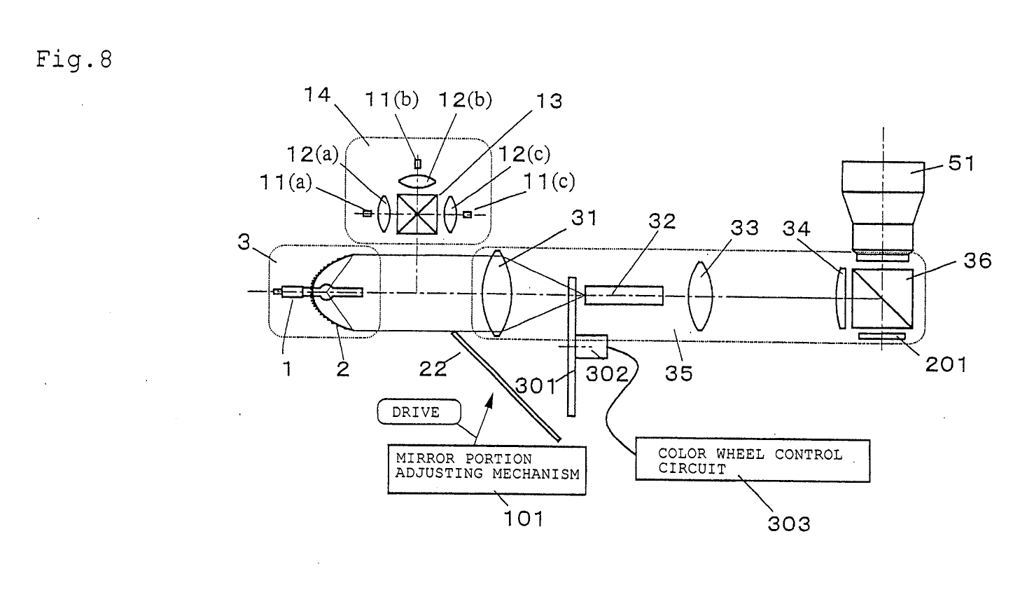

Thus, even if the reflective indicating element 201 is one optical system, it is possible to make a selection, such as having the luminous flax emitted from the solid state light source unit 14 enter the lighting unit 35 by means of the movable mirror 21 as shown in FIG. 7 or having the luminous flax emitted from the lamp unit 3 enter the lighting unit 35 by moving the movable mirror 22 as shown in FIG. 8 so as to have the same effects as the first embodiment.

Furthermore, in the case of using the optical system shown in FIG. 7, the extra high pressure mercury lamp 1 that is the same as a conventional lamp has the white light emitted from one light source so that the white light has to be color-separated by a color separation filter in chronological order by means of the color wheel 301. However, the solid state light source such as the light-emitting diodes 11(a) to 11(c) is a monochromatic light source. Therefore, in the case of the solid state light source unit 14 using the light-emitting diodes 11(a) to 11(c) in three colors shown in FIG. 7, it is easy to perform color separation in chronological order by delaying lighting time of the light-emitting diodes 11(a) to 11(c) in each of the colors.

For this reason, it is no longer essential to rotatively drive the color wheel 301 in the case of inserting the movable mirror 21 and having the luminous flax emitted from the solid state light source unit 14 enter the lighting unit 35. For this reason, in the case where the color wheel 301 is composed of a four-color filter as the color wheel 401 of FIG. 9, the color wheel 401 is stopped in the region 402 where passing light turns to white so that the power for operating the color wheel 401 becomes no longer necessary and the power consumption can be reduced as the effects thereof.

In the case of starting up with the supply of power from the AC power supply for changing the luminous flax entering the lighting unit 35 as time elapses from the luminous flax emitted from the solid state light source unit 14 to the luminous flax emitted from the lamp unit 3 and in the lamp mode, the number of revolutions of the driving motor 302 for rotating the color wheel 301 does not rise precipitously. Therefore, it will not be in time if the color wheel 301 is rotated on switching to the luminous flax emitted from the lamp unit 3. In this case, it is preferable, even when using the luminous flax emitted from the solid state light source unit 14, to rotate the color wheel 301 so as to be in synchronization with the lighting time of the light-emitting diodes 11(a) to 11(c).

In the case of the color wheel 411 with no white region as in FIG. 10, it is desirable to rotate the color wheel 411 in synchronization with the lighting time of the light-emitting diodes 11(a) to 11(c) so that a luminescent color of the diodes matches with the color of the region for passing the light path.

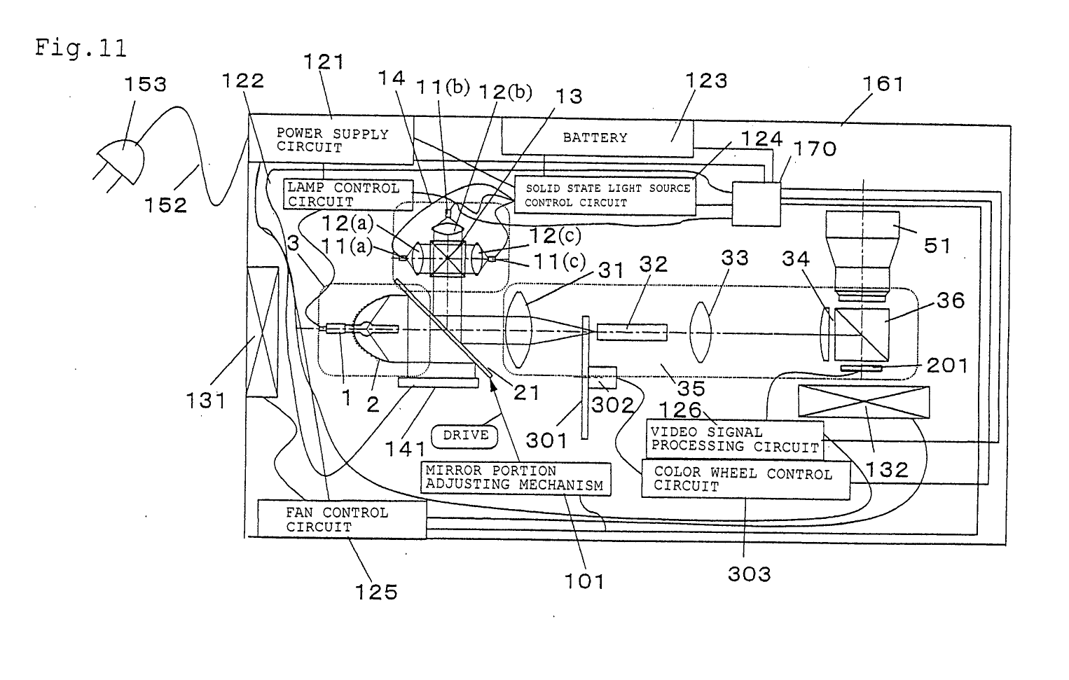

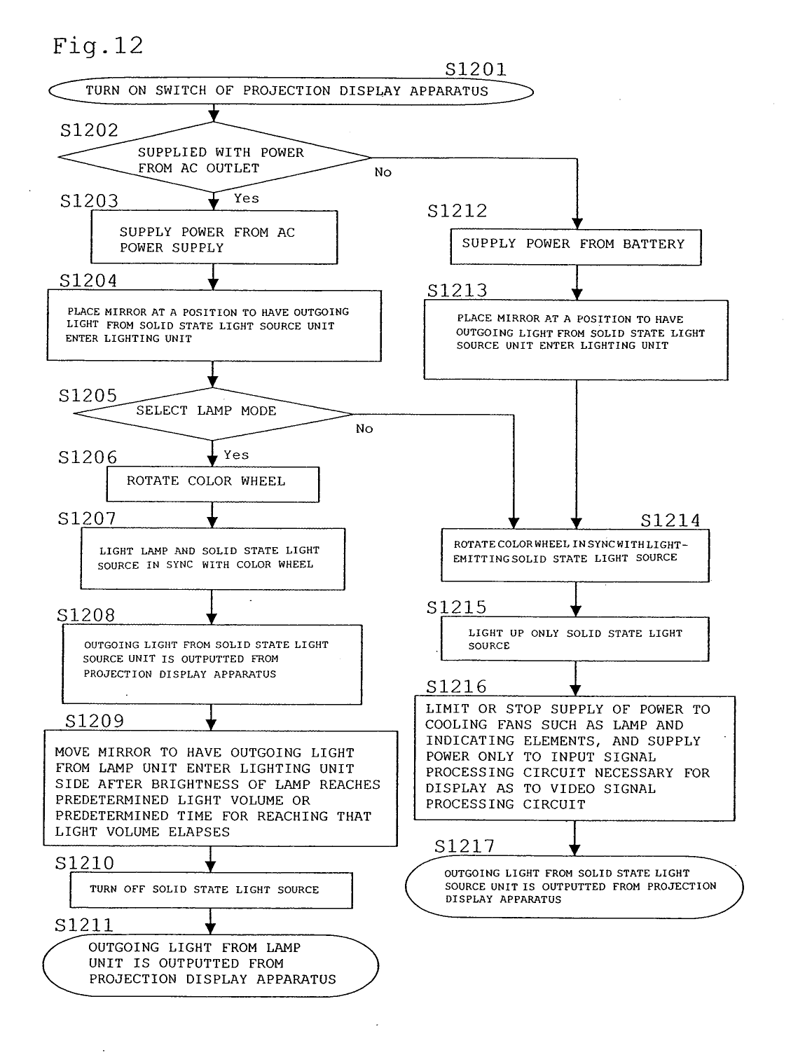

Next, FIG. 11 shows the schematic overall block diagram of a projection display apparatus 161 including the power supply for driving the lamp unit 3 and the like as with the second embodiment. In FIG. 11, however, the portions that are the same as or equivalent to those of FIGS. 5 and 7 are given the same symbols, and a detailed description thereof will be omitted. The control circuit 170 is different from the example shown in FIG. 5 in that it also controls the operation of the color wheel control circuit 303. Hereunder, a description will be given by referring to a flowchart of FIG. 12 as to control operation of the control circuit 170 for the power saving by the projection display apparatus 161.

First, the main power switch (not shown) of the projection display apparatus 161 is turned on (S1201).

And it is determined by referring to the state of the power supply circuit 121 whether or not the projection display apparatus 161 is supplied with the power from the AC outlet 153 (S1202). In this case, the procedure thereafter is different between the case of being supplied with the power from the AC power supply (S1203) and the case of being supplied with the power from the battery 123 (S1212).

In the case where the power is supplied from the AC power supply, the movable mirror 21 is placed at a position to have the outgoing light from the solid state light source unit 14 enter the lighting unit 35 (S1204).

In the case of supplying the power from the AC power supply in particular, it is selectable by the user whether to display a bright projected image by using the extra high pressure mercury lamp 1 (lamp mode) or display the projected image by using the light-emitting diodes 11(a) to 11(c) (solid state light source mode) for the sake of reducing the power consumption (S1205). In the case where the lamp mode for using the extra high pressure mercury lamp 1 is selected for instance, the color wheel 301 is rotated (S1206), the extra high pressure mercury lamp 1 is lit up and the light-emitting diodes 11(a) to 11(c) are sequentially lit up in chronological order in synchronization with the color wheel 301 (S1207) . As a lighting form in this case, the light-emitting diodes 11(a) to 11(c) are selectively lit up in synchronization with the color wheel 301. Therefore, one of the light-emitting diodes 11(a) to 11(c) in the same color as the region of the color wheel 301 located in the light path of the lighting unit 35 (corresponding one of the regions 403 to 405 of the color wheel 401 shown in FIG. 9) is lit up. All the three colors of the light-emitting diodes 11(a) to 11(c) are lit up only in the case of the white region of the color wheel 301 (equivalent to the region 402 of the color wheel 401 shown in FIG. 9).

In this case, the movable mirror 21 is placed at the position to have the outgoing light from the solid state light source unit 14 enter the lighting unit 35 in the preceding stage, and so the outgoing light from the light-emitting diodes 11(a) to 11(c) as the light source of the solid state light source unit 14 is emitted from the projection lens first (S1208).

And it is checked that the brightness of the extra high pressure mercury lamp 1 has reached a predetermined light volume by becoming larger than the light volume emitted from the light-emitting diodes 11(a) to 11(c) or reaching the predetermined brightness of the light emitted from the extra high pressure mercury lamp 1. Or else, the estimated time for reaching the predetermined light volume is measured in advance, and the movable mirror 21 is moved to have the outgoing light from the lamp unit 3 enter the lighting unit 35 side after the estimated time for reaching the predetermined brightness elapses from lighting of the extra high pressure mercury lamp 1 or switch-on of the projection display apparatus 161 (S1209). According to this embodiment, the estimated time is the time until the light volume as the actual measurement value measured by the light volume sensor 141 reaches the fixed value measured in advance and preset in the control circuit 170 as in the second embodiment.

As the light entering the lighting unit 35 side is only the luminous flax of the extra high pressure mercury lamp 1 of the lamp unit 3, the light-emitting diodes 11(a) to 11(c) of the solid state light source unit 14 are turned off (S1210).

Thus, even in the case where the power is supplied from the external AC power supply and the lamp mode is selected according to this work procedure, it has the effect of obtaining the same bright projected image as before by means of the extra high pressure mercury lamp 1 while allowing the instantaneous lighting (S1211).

Furthermore, in the case where the main power switch of the projection display apparatus 161 is turned on in a state of having no utility power supplied from the AC outlet 153, it is detected that the power is supplied from the battery 123 (S1212). And first, the movable mirror 21 is placed at the position to have the outgoing light from the solid state light source unit 14 enter the lighting unit 35 (S1213).

In this case, if the color wheel 301 has the white region (equivalent to the white region 402 of the color wheel 401 shown in FIG. 9), it is stopped in a state of being placed to render the region located in the light path of the lighting unit 35 as the white region so as to pass the white region (S1214) . It is thereby possible to have the effect of reducing the power consumption of the driving motor 302 for rotating the color wheel 301.

In this case, only the light-emitting diodes 11(a) to 11(c) are lit up all together with the extra high pressure mercury lamp 1 turned off (S1215).

In the case where the power is supplied from the AC power supply and the lamp mode is not selected (S1205), the color wheel 301 is stopped at the predetermined position (S1214) and only the light-emitting diodes 11(a) to 11(c) are lit up with the extra high pressure mercury lamp 1 turned off likewise (S1215).

In the case where the power is supplied from the battery, only the light-emitting diodes 11(a) to 11(c) are lit up in order to save power as the projection display apparatus 161 on the whole. Therefore, it limits or stops the supply of power to the cooling fans 131, 132 for mainly cooling the extra high pressure mercury lamp 1 and the reflective indicating element 201 by the control of the fan control circuit 125, and also has only the minimum power necessary for display supplied to the video signal processing circuit 126 (S1216).

Thus, in the case where the power is supplied from the battery 123 according to this embodiment, it has the effects of allowing the power consumption to be further reduced and allowing the projected image to be displayed by the solid state light source unit 14 as in the second embodiment (S1217).

It has been described that the items to be determined indicated in the work procedure are handled by the control circuit 170 in the projection display apparatus 161. However, they may be determined automatically by the software (program) . It is also possible for the user to make determinations and have the control circuit 170 operate as the interface for receiving them.

As for the movement of the movable mirror 21 indicated in the work procedure, the mobile mirror portion adjusting mechanism 101 with a motor which is automatically drivable is moved automatically by the software (program) as the control circuit 170. However, it may also be moved manually.

As for the turn-on and turn-off of the light sources indicated in the work procedure, they are controlled by the lamp control circuit 122 and solid state light source control circuit 124. However, they may be turned on and off automatically by the software (program) or turned on and off manually by the user.

The color wheel 301 is synchronized with the light-emitting diodes 11(a) to 11(c) and stopped at the predetermined position as indicated in the work procedure by the control of the color wheel control circuit 303 in the projection display apparatus 161. However, it may be driven automatically by the software (program) or driven manually by the user.

According to the description, the color wheel 301 is the four-color filter as exemplified in FIG. 9. In the case where the color wheel 301 is the three-color filter of red, blue and green as exemplified in FIG. 10, however, it is necessary to have the color wheel 301 synchronized with the luminescent colors of the light-emitting diodes 11(a) to 11(c) without fail even if the power is supplied from the battery 123. In this case, the operation of stopping the color filter located in the light path of the lighting unit 35 in the state of being placed to become white (S1214) in FIG. 12 according to the description is changed to the operation of rotating the color wheel 301 in synchronization with the luminescent colors of the light-emitting diodes 11(a) to 11(c).

The program involved in the present invention is the program for causing a computer to execute all or a part of the functions of the control instrument for the above-mentioned projection display apparatus of the present invention. It may be a program operating in cooperation with the computer.

The present invention may also be a medium having the program for causing the computer to execute all or a part of the functions of all or a part of the instruments of the control instrument for the above-mentioned projection display apparatus of the present invention recorded thereon, in which the program readable and read by the computer executes the functions in cooperation with the computer.

The present invention also includes a computer-readable recording medium having the program of the present invention recorded thereon.

A type of usage of the program of the present invention maybe an aspect of being recorded on the computer-readable recording medium and operating in cooperation with the computer.

A type of usage of the present invention may also be an aspect of being transmitted in a transmission medium, read by the computer and operating in cooperation with the computer.

The recording media include an ROM and the like, and the transmission media include a transmission mechanism such as the Internet, light, radio waves, sound waves and the like.

The above-mentioned computer of the present invention is not limited to sheer hardware such as a CPU, but may also include firmware, an OS and peripherals in addition.

As described above, the configuration of the present invention may be implemented either software-wise or hardware-wise.

### INDUSTRIAL APPLICABILITY

The projection display apparatus of the present invention is applicable to a display apparatus capable of projecting an image, such as a projection display apparatus expectedly having the effects of realizing the brightness equal to the conventional apparatuses, displaying a bright projected image upon the supply of power and having good portability.

1. A projection display apparatus comprising:
a first light generating instrument which includes a light source that generates white light;
a second light generating instrument which includes a plurality of solid state light sources which generate red, green, and blue monochromatic light respectively;
a light modulation element which modulates the white light when the white light is received and which modulates the monochromatic light when the monochromatic light is received;
a light guiding instrument which switches between guiding the white light and the monochromatic light to the light modulation element; and
a projection instrument which projects the light modulated by the light modulation element.

2. The projection display apparatus according to claim 1, comprising a color wheel including first, second and third regions corresponding to red, green, and blue colors respectively, the first, second and third regions circularly arranged in chronological order.

3. The projection display apparatus according to claim 2, in which the second light modulation element lights up the solid light sources selectively so that there is a match between a color corresponding to one of the regions of the color wheel located in a light path and the color of the monochromatic light.

4. The projection display apparatus according to claim 2, in which the color wheel further includes a region corresponding to white, and stops in a state of having the region corresponding to white located in a light path while the monochromatic light is selected by the light guiding instrument.

5. The projection display apparatus according to claim 1, wherein:
the light modulation element includes first, second and third light modulation elements provided respectively corresponding to solid state light sources of the monochromatic light; and
the light guiding instrument includes:
a first dichroic filter placed on an optical axis of the white light from the first light modulation element;
a first reflecting mirror placed in front of a light incident side of the first light modulation element, a second dichroic filter placed in front of the light incident side of the second light modulation element, and a second reflecting mirror placed on the optical axis of the light transmitted through the first and second dichroic filters of the light from the first light modulation element; and
a third reflecting mirror placed in front of the light incident side of the third light modulation element.

6. The projection display apparatus according to claim 1, further comprising:
a control instrument which controls at least operation of the light guiding instrument, and wherein:
the control instrument controls the light guiding instrument to guide the monochromatic light to the light modulation element and further controls the light guiding instrument after a predetermined time to guided the white light to the light modulation element.

7. The projection display apparatus according to claim 6, wherein:
the control instrument controls the first light generating instrument and the second light generating instrument so that
the second light generating instrument generates the monochromatic light while the light guiding instrument is guiding the monochromatic light to the light modulation element, and
the first light generating instrument generates the white light while the light guiding instrument is guiding the white light to the light modulation element.

8. The projection display apparatus according to claim 7, wherein:
the control instrument includes a light volume measuring instrument which at least measures a light volume of the first light generating instrument, and controls the light guiding instrument to guide the white light to the light modulation element at the time as the predetermined time, when the light volume measured by the light volume measuring instrument becomes equal to or more than a predetermined value.

9. The projection display apparatus according to claim 5, further comprising:
collector optics for collecting the white light or the monochromatic light on the light modulation element, and wherein:
the light guiding instrument selectively guides the white light or the monochromatic light to the collector optics and thereby guides the white light or the monochromatic light selectively to the light modulation element.

10. The projection display apparatus according to claim 9, wherein:
an optical axis of the white light generated by the first light generating instrument between the first light generating instrument and the collector optics is substantially on a straight line; and
the optical axis of the monochromatic light generated by the second light generating instrument between the second light generating instrument and the collector optics is bent via the light guiding instrument.

11. The projection display apparatus according to claim 9, wherein:
the optical axis of the monochromatic light generated by the second light generating instrument between the second light generating instrument and the collector optics is substantially on a straight line; and
the optical axis of the white light generated by the first light generating instrument between the first light generating instrument and the collector optics is bent via the light guiding instrument.

12. The projection display apparatus according to claim 7, wherein:
the first light generating instrument is driven by a first power supply based on supply of power from outside;
the second generating instrument is driven by a second power supply which is a built-in power supply;
the control instrument monitors a status of the first power supply and the second power supply;
the control instrument controls the light guiding instrument to guide the monochromatic light to the light modulation element irrespective of the state of the first power supply and the second power supply, and exerts control, on detecting that at least the first power supply is supplied with the power from outside, to operate the second light generating instrument and then the first light generating instrument.

13. The projection display apparatus according to claim 1, in which the second light generating instrument is a light-emitting diode or a laser diode.

14. The projection display apparatus according to claim 1, in which the first light generating instrument is a lamp which emits light by arc discharge.

15. The projection display apparatus according to claim 1, in which the light guiding instrument includes a mirror surface located between the optical axis of the white light and the optical axis of the monochromatic light by rotation or parallel movement.

16. An image display method using:
a first light generating instrument which generates white light;
a second light generating instrument which includes a plurality of solid state light sources and thereby generates more than or equal to three kinds of monochromatic light;
a light modulation element which modulates the white light when the white light is received and which modulates the monochromatic light when the monochromatic light is received; and
a projection instrument which projects the light modulated by the light modulation element, and wherein:
the method includes a light guiding step of switching between guiding the white light and the monochromatic light to the light modulation element; and
the light guiding step guides the monochromatic light to the light modulation element and then guides the white light to the light modulation element.

17. (canceled)

18. A recording medium which is recorded a program and processable by the computer, wherein the program is for causing a computer to function as a control instrument which controls at least operation of the light guiding instrument of the projection display apparatus according to claim 6.
